(19) United States
(12) Patent Application Publication
(10) Pub. No.: US 2026/0169421 A1
(43) Pub. Date: Jun. 18, 2026

(54) MULTI-FUNCTION PERIPHERAL

(71) Applicant: Kinpo Electronics, Inc., New Taipei City (TW)

(72) Inventors: Hung-Wei Huang, New Taipei City (TW); Tsung-Hua Kuo, New Taipei City (TW); Yao-Te Huang, New Taipei City (TW); Kuei-Mei Liu, New Taipei City (TW); Wei-Xiang Lin, New Taipei City (TW)

(73) Assignee: Kinpo Electronics, Inc., New Taipei City (TW)

(21) Appl. No.: 19/019,505

(22) Filed: Jan. 14, 2025

(30) Foreign Application Priority Data
Dec. 12, 2024 (TW) 113148513

(51) Int. Cl. G03G 15/00; B23K 26/38; B41J 2/44; B41J 2/47; G03G 15/04; G03G 15/043

(52) U.S. Cl. CPC G03G 15/6582; B23K 26/38; B41J 2/442; B41J 2/471; G03G 15/04036; G03G 15/0409; G03G 15/0435; G03G 2215/00721; G03G 2215/00814

(57) ABSTRACT

Provided is a multi-function peripheral, which includes a body, a laser scanning module, and a control module. The body has a sheet feeding area, a sheet transport path, and a sheet output area. An upstream of the sheet transport path is connected to the sheet feeding area. A downstream of the sheet transport path is connected to the sheet output area. The laser scanning module disposed in the body includes a laser emitter, a rotary polygon mirror, and a reflection module. The control module is electrically connected to the laser emitter, the rotary polygon mirror and the reflection module to drive the laser emitter to generate a first beam emitted to the rotary polygon mirror, reflected through the rotary polygon mirror into multiple second beams emitted to the reflection module, and then reflected from the reflection module into multiple third light beams emitted to the downstream.

### CROSS-REFERENCE TO RELATED APPLICATION

This application claims the priority benefit of Taiwan application serial no. 113148513, filed on Dec. 12, 2024. The entirety of the foregoing patent application is hereby incorporated by reference herein and made a part of this specification.

### BACKGROUND

### Technical Field

The disclosure relates to a multi-function peripheral.

### Description of Related Art

The laser scanning modules of the existing multi-function peripherals or laser printers are only used as a basic printing precursor technology. Once there are additional usage needs, additional functional modules may need to be added inside or around the machine.

For example, when a content to be printed is no longer a basic document, but a content of unusual dimensions such as photos, business cards, pictures, etc., the user is faced with the need for a next step of cutting into an appropriate dimension, and this part is obviously beyond the capabilities of the existing equipment.

### SUMMARY

The disclosure provides a multi-function peripheral, which uses a laser scanning module to have both printing and cutting functions at the same time and improves the applicability of the peripheral.

The multi-function peripheral of the disclosure includes a body, a laser scanning module, and a control module. The body has a sheet feeding area, a sheet transport path and a sheet output area. An upstream of the sheet transport path is connected to the sheet feeding area. A downstream of the sheet transport path is connected to the sheet output area. The laser scanning module disposed in the body includes a laser emitter, a rotary polygon mirror, and a reflection module. The control module is electrically connected to the laser emitter, the rotary polygon mirror and the reflection module to drive the laser emitter to generate a first beam emitted to the rotary polygon mirror, reflected through the rotary polygon mirror into multiple second beams emitted to the reflection module, and then reflected from the reflection module into multiple third beams emitted to the downstream. The third beams perforate at intervals on a sheet to form a pre-cut line when the sheet passes through the downstream.

In an embodiment of the disclosure, the multi-function peripheral further includes an electronic imaging system, which is electrically connected to the control module and located in the upstream of the sheet transport path. The control module drives the laser emitter to generate a fourth beam emitted to the rotary polygon mirror, reflected through the rotary polygon mirror into multiple fifth beams emitted to the reflection module, and then reflected from the reflection module into multiple sixth beams emitted to the electronic imaging system located in the upstream, so that the sixth beams drive the electronic imaging system to print a pattern on the sheet when the sheet passes through the upstream. The pre-cut line is located around the pattern.

In an embodiment of the disclosure, the foregoing reflection module includes a reflection glass and a driving assembly. The driving assembly is connected to the reflection glass and electrically connected to the control module. The control module rotates the reflection glass through the driving assembly to allow the reflection glass to convert between a first position and a second position. The reflection glass is configured to receive the fifth beams to reflect the sixth beams in the first position. The reflection glass is configured to receive the second beams to reflect the third beams in the second position.

In an embodiment of the disclosure, the foregoing driving assembly includes a motor and a gear set. The motor is electrically connected to the control module. The gear set is connected between the motor and the reflection glass.

In an embodiment of the disclosure, the foregoing driving assembly further includes a blocking member and a position sensor. The blocking member is disposed on the gear set to rotate with the gear set. The position sensor is electrically connected to the control module and located on a moving path of the blocking member.

In an embodiment of the disclosure, the foregoing control module is informed whether the reflection glass is in the second position through whether the position sensor senses the blocking member.

In an embodiment of the disclosure, the foregoing laser emitter is controlled by the control module to allow an energy of the first beam to be greater than an energy of the fourth beam.

In an embodiment of the disclosure, the multi-function peripheral further includes multiple sensors, which are respectively electrically connected to the control module and located on the sheet transport path. The control module is informed that the sheet is in a position on the sheet transport path according to the sensors.

Based on the above, the sheet transport path in the multi-function peripheral is divided into the upstream and the downstream. The laser scanning module is driven by the control module to provide the third beams emitted to the downstream, thereby when the sheet passes through the downstream, the third beams may perforate at intervals thereon to form the pre-cut line. In other words, when the sheet is moved out of the body, the sheet is already in a pre-cut state, that is, the pre-cut line is disposed around the pattern. The user only needs to follow the pre-cut line to remove a non-printing area of the sheet, thereby saving the need to use additional tools to cut the sheet, and improving the applicable scope of the multi-function peripheral at the same time.

### BRIEF DESCRIPTION OF THE DRAWINGS

FIG. 1 is a simple side view of a multi-function peripheral according to an embodiment of the disclosure.

FIG. 2 is another state of the multi-function peripheral in FIG. 1.

FIG. 3 is a top view of a laser scanning module.

FIG. 4 is a schematic view of electrical connections of related components of a multi-function peripheral.

FIG. 5A is a top view of related components of a reflection module.

FIG. 5B and FIG. 5C are different states of a reflection module respectively illustrated from a side view.

FIG. 6 is a state where a sheet has been printed and cut.

### DESCRIPTION OF THE EMBODIMENTS

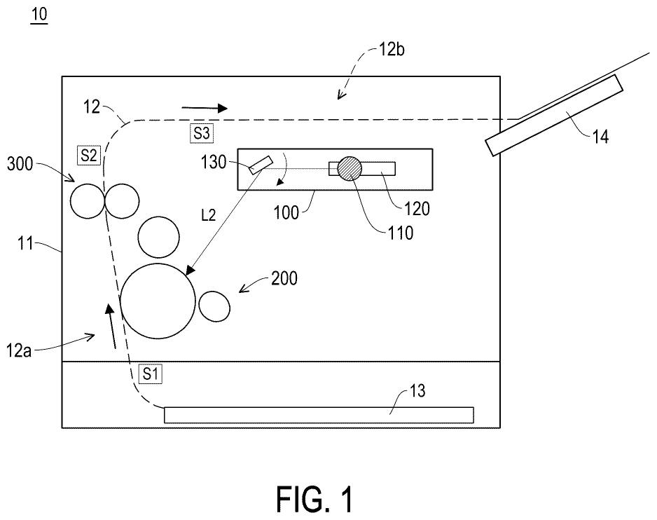

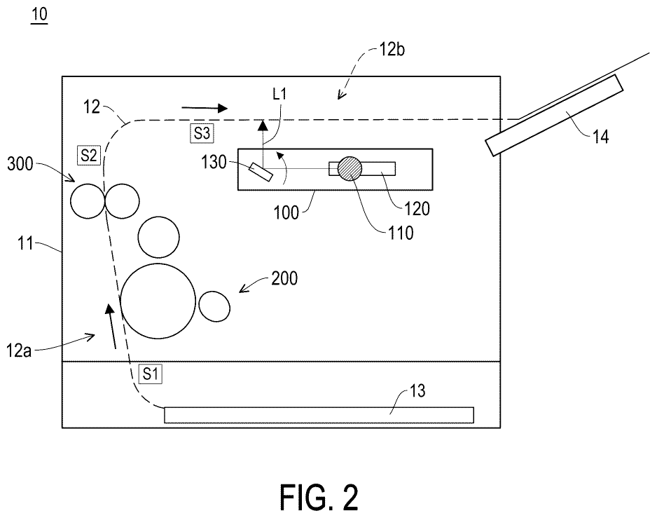

FIG. 1 is a simple side view of a multi-function peripheral according to an embodiment of the disclosure. FIG. 2 is another state of the multi-function peripheral in FIG. 1. A multi-function peripheral 10 shown in FIG. 1 is in a printing state. The multi-function peripheral 10 shown in FIG. 2 is in a cutting state. Please refer to FIG. 1 and FIG. 2 at the same time. In the embodiment, the multi-function peripheral 10 includes a body 11 and a laser scanning module 100. The body 11 has a sheet feeding area 13, a sheet transport path 12 and a sheet output area 14. An upstream 12a of the sheet transport path 12 is connected to the sheet feeding area 13. A downstream 12b of the sheet transport path 12 is connected to the sheet output area 14. The sheet feeding area 13 is provided with a sheet tray or a sheet inlet for manual feeding to allow a sheet to be brought into the sheet transport path 12 by a driving wheel (not shown) from the sheet feeding area 13. After the sheet is processed on the sheet transport path 12, the driving wheel (not shown) transports the sheet from the sheet transport path 12 to the sheet output area 14 to allow the user to smoothly take out the sheet from the sheet output area 14.

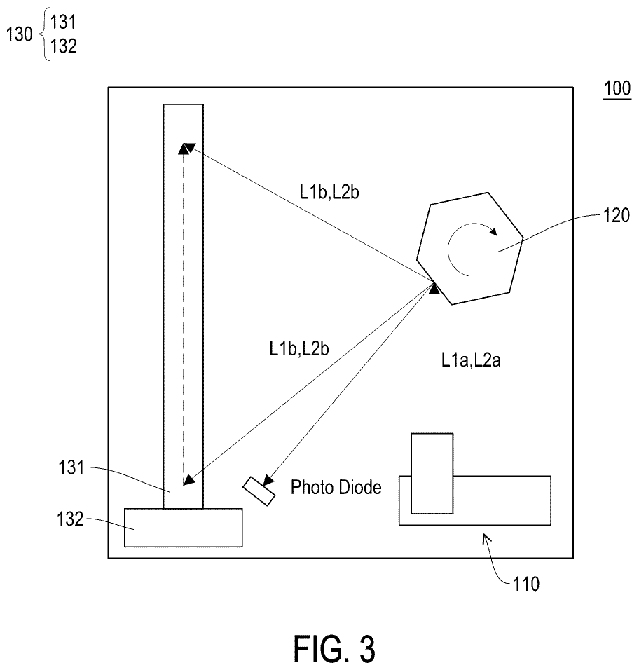

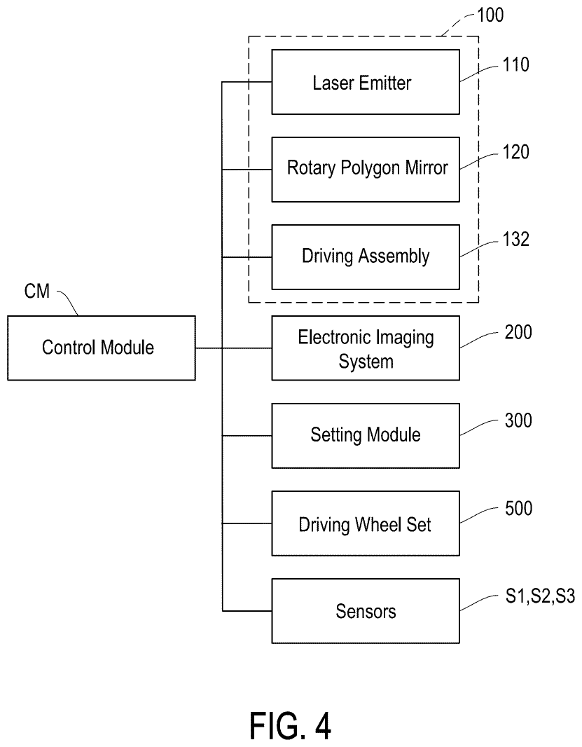

FIG. 3 is a top view of a laser scanning module. FIG. 4 is a schematic view of electrical connections of related components of a multi-function peripheral. Please refer to FIG. 2 to FIG. 4 at the same time. The multi-function peripheral 10 further includes a control module CM. The laser scanning module 100 disposed in the body 11 includes a laser emitter 110, a rotary polygon mirror 120 and a reflection module 130. The control module CM is electrically connected to the laser emitter 110, the rotary polygon mirror 120 and the reflection module 130 to drive the laser emitter 110 to generate a first beam L1a emitted to the rotary polygon mirror 120, reflected through the rotary polygon mirror 120 into multiple second beams L1b emitted to a reflection glass 131 of the reflection module 130, and then reflected from the reflection glass 131 of the reflection module 130 into multiple third beams L1 emitted to the downstream 12b. When the sheet passes through the downstream 12b, the third beams L1 perforate at intervals on the sheet to form a pre-cut line.

Furthermore, as shown in FIG. 1, FIG. 2 and FIG. 4, the multi-function peripheral 10 further includes an electronic imaging system 200 and a setting module 300, which are respectively electrically connected to the control module CM and located in the upstream 12a of the sheet transport path 12. As shown in FIG. 1, FIG. 3 and FIG. 4, the control module CM drives the laser emitter 110 to generate a fourth beam L2a emitted to the rotary polygon mirror 120, reflected through the rotary polygon mirror 120 into multiple fifth beams L2b emitted to the reflection glass 131 of the reflection module 130, and then reflected from the reflection glass 131 of the reflection module 130 into multiple sixth beams L2 emitted to the electronic imaging system 200 located in the upstream 12a, so that when the sheet passes through the upstream 12a, the sixth beams L2 drive the electronic imaging system 200 to print the pattern on the sheet.

Here, the printing operation performed by the laser scanning module 100, the electronic imaging system 200 and the setting module 300 is the same as the laser printing operation in the existing technology. Generally speaking, (static) electricity is first distributed on the surface of the photosensitive drum of the electronic imaging system 200, and then the sixth beams L2 of the laser scanning module 100 project the pattern image needed on the surface of the photosensitive drum to allow the part projected by the laser beam to discharge. Then, a toner is coated on the surface of the photosensitive drum. The charged toner may be adsorbed on the region projected by the laser beam to achieve the development (image) effect. Then, the toner on the photosensitive drum is transferred to the sheet. Finally, the sheet is allowed to pass through the setting module 300 to heat and pressurize the toner on the sheet to fuse onto the sheet to achieve the setting (shadow) effect.

It can be clearly seen from the foregoing two different operating modes that the same laser scanning module 100 may meet the needs for printing and cutting to allow the sheet to achieve printing and cutting at the same time during the process of moving on the sheet transport path 12. As shown in FIG. 3, for the laser scanning module 100, the operating mode from the laser emitter 110 through the rotary polygon mirror 120 to the reflection module 130 is not different. Only the reflection module 130 needs to project the corresponding beam (the third beams L1 or the sixth beams L2) to the region needed (the electronic imaging system 200 located in the upstream 12a or the downstream 12b).

The component configuration and related technical features of the laser scanning module 100 needed to achieve the foregoing different operations are described in detail below. Please refer to FIG. 1, FIG. 2 and FIG. 4 again. No matter what kind of the foregoing operation is performed, the control module CM of the embodiment may allow the speed of the sheet on the sheet transport path 12 to be consistent through a driving wheel set 500 to facilitate the printing operation and the cutting operation of the sheet to be in conjunction with each other during the moving process. Furthermore, the multi-function peripheral 10 of the embodiment further includes multiple sensors S1, S2, and S3, which are disposed on the sheet transport path 12 and electrically connected to the control module CM, allowing the control module CM to monitor the position of the sheet on the sheet transport path 12 in real time. The sensor S1 is located between the sheet feeding area 13 and the electronic imaging system 200, the sensor S2 is located at the outlet of the setting module 300, and the sensor S3 is located in the projection region of the third beam L1 on the sheet transport path 12 to better control the conjunctional relationship between the position of the sheet and the printing and cutting operations.

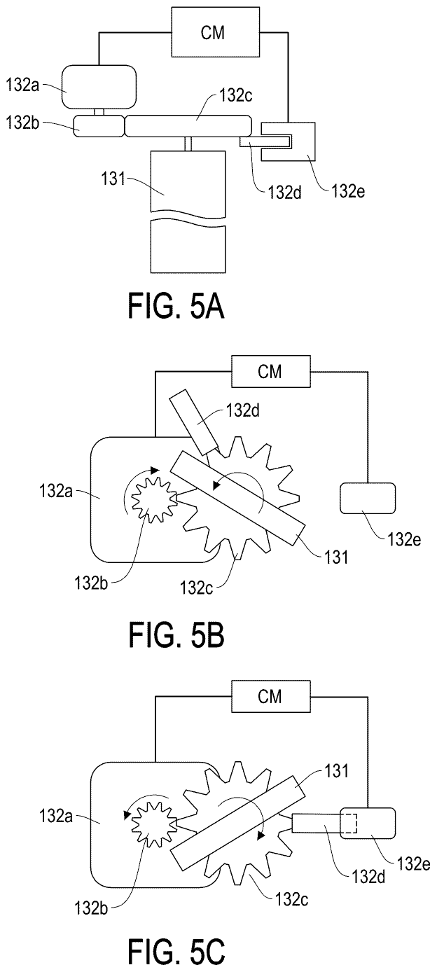

FIG. 5A is a top view of related components of a reflection module. FIG. 5B and FIG. 5C are different states of a reflection module respectively illustrated from a side view. Please refer to FIG. 3, FIG. 4 and FIG. 5A first. In the embodiment, the reflection module 130 further includes a driving assembly 132, which is connected to the reflection glass 131 and electrically connected to the control module CM. Accordingly, as shown in FIG. 5B and FIG. 5C, the control module CM rotates the reflection glass 131 through the driving assembly 132 to allow the reflection glass 131 to convert between a first position (FIG. 5C) and a second position (FIG. 5B). Please refer to FIG. 1 to FIG. 3. When the sheet reaches the upstream 12a, the reflection glass 131 is rotated to the first position, and the reflection glass 131 is configured to receive the fifth beams L2b to reflect the sixth beams L2 to perform the printing operation shown in FIG. 1. When the sheet continues to the downstream 12b, the reflection glass 131 is rotated to the second position, and the reflection glass 131 is configured to receive the second beams L1b to reflect the third beams L1 to perform the puncturing operation.

The driving assembly 132 of the embodiment includes a motor 132a and gear sets 132b and 132c. The motor 132a is electrically connected to the control module CM, and the gear sets 132b and 132c are connected between the motor 132a and the reflection glass 131. Therefore, the control module CM may drive the reflection glass 131 to rotate through the motor 132a and the gear sets 132b and 132c to allow the laser beam to be projected to the region where the electronic imaging system 200 located in the upstream 12a or the downstream 12b perforates the sheet.

Furthermore, in order to improve the rotation accuracy of the reflection glass 131, in addition to a stepper motor used in the motor 132a, the driving assembly 132 further includes a blocking member 132d and a position sensor 132e. The blocking member 132d is disposed on (a gear of) the gear sets 132b and 132c to rotate with the gear sets 132b and 132c. The position sensor 132e is electrically connected to the control module CM and located on the moving path of the blocking member 132d. The control module CM is informed whether the reflection glass 131 is located in the foregoing first position through whether the position sensor 132e senses the blocking member 132d. In other words, the functions of the blocking member 132d and the position sensor 132e in the embodiment are mainly to ensure that the reflection glass 131 has indeed returned to a correct position for the laser printing operation to ensure that the sixth beams L2 may be accurately projected to the electronic imaging system 200, and effectively avoids the accumulation of tolerances caused by repeated rotations. On the contrary, the blocking member 132d and the position sensor 132e may also serve as a means to determine whether the reflection glass 131 is located in the foregoing first position.

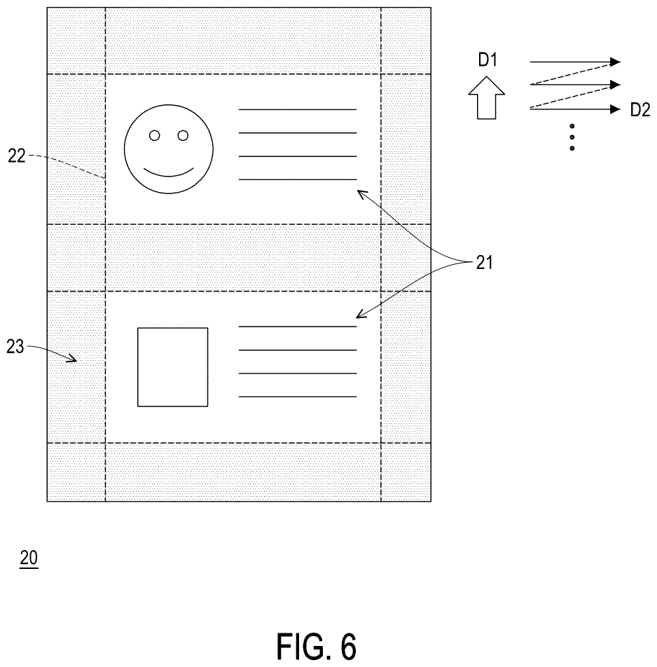

FIG. 6 is a state where a sheet has been printed and cut. Please refer to FIG. 1, FIG. 2 and FIG. 6 at the same time. Here only an overall view of the effect that may be obtained after a same sheet 20 passes through the sheet transport path 12 is taken. The sheet 20 advances along a sheet feeding direction D1. The laser scanning module 100 prints or cuts the sheet 20 in a scanning direction D2. In other words, the laser scanning module 100 performs the actions of scanning and printing, and scanning and cutting in the same behavior mode. In the former, the control module CM drives the laser emitter 110 to provide a beam with a power of several milliwatts (mW) to perform the scanning action of the pattern image on the photosensitive drum, thereby forming the pattern within printing areas 21 on the sheet 20. In the latter, the control module CM drives the laser emitter 110 to provide beams with powers of several watts to tens of watts to perforate at intervals on the sheet 20 according to the purpose of perforation, thereby forming a pre-cut line 22 in the form of a dotted line structure or a stitched line structure around the printing areas 21. In this way, as shown in FIG. 6, after the two operations are completed, the printing areas 21 and a non-printing area 23 may be separated by the pre-cut line 22 on the sheet 20. The user only needs to tear off the non-printing area 23 from the sheet 20 along the pre-cut line 22 to obtain the printing areas 21 needed.

In summary, according to the foregoing embodiment of the disclosure, the sheet transport path in the multi-function peripheral is divided into the upstream and the downstream. The laser scanning module is driven by the control module to provide the third beams, which illuminate to the downstream, thereby when the sheet passes through the downstream, the third beams may perforate at intervals thereon to form the pre-cut line. In addition, the multi-function peripheral may further provide the sixth beams, which illuminate to the electronic imaging system located in the upstream, through the same laser scanning module to perform the basic printing operation on the sheet passing through the upstream. In other words, the multi-function peripheral only needs to adjust the beam projection position and the beam power of the laser scanning module to allow the sheet to complete both the printing and pre-cutting operations within the body.

Accordingly, when the sheet is moved out of the body, the sheet is already in a pre-cut state, that is, the pre-cut line is disposed around the printing areas where the patterns exist. The user only needs to follow the pre-cut line to remove the non-printing area of the sheet, thereby saving the need to use additional tools to cut the sheet, and improving the applicable scope of the multi-function peripheral at the same time.

What is claimed is:

1. A multi-function peripheral, comprising:
a body, having a sheet feeding area, a sheet transport path and a sheet output area, wherein an upstream of the sheet transport path is connected to the sheet feeding area, and a downstream of the sheet transport path is connected to the sheet output area;
a laser scanning module, disposed in the body, comprising:
a laser emitter, a rotary polygon mirror and a reflection module; and
a control module, electrically connected the laser emitter, the rotary polygon mirror and the reflection module to drive the laser emitter to generate a first beam emitted to the rotary polygon mirror, reflected through the rotary polygon mirror into a plurality of second beams emitted to the reflection module, and then reflected from the reflection module into a plurality of third beams emitted to the downstream,
wherein the third beams perforate at intervals on a sheet to form a pre-cut line when the sheet passes through the downstream.

2. The multi-function peripheral according to claim 1, further comprising an electronic imaging system, electrically connected to the control module and located in the upstream of the sheet transport path, wherein the control module drives the laser emitter to generate a fourth beam emitted to the rotary polygon mirror, reflected through the rotary polygon mirror into a plurality of fifth beams emitted to the reflection module, and then reflected from the reflection module into a plurality of sixth beams emitted to the electronic imaging system located in the upstream, so that the sixth beams drive the electronic imaging system to print a pattern on the sheet when the sheet passes through the upstream, and the pre-cut line is located around the pattern.

3. The multi-function peripheral according to claim 2, wherein the reflection module comprises:
a reflection glass; and
a driving assembly, connected to the reflection glass and electrically connected to the control module, wherein the control module rotates the reflection glass through the driving assembly to allow the reflection glass to convert between a first position and a second position, wherein
the reflection glass is configured to receive the fifth beams to reflect the sixth beams in the first position, and
the reflection glass is configured to receive the second beams to reflect the third beams in the second position.

4. The multi-function peripheral according to claim 3, wherein the driving assembly comprises:
a motor, electrically connected to the control module; and
a gear set, connected between the motor and the reflection glass.

5. The multi-function peripheral according to claim 4, wherein the driving assembly further comprises:
a blocking member, disposed on the gear set to rotate with the gear set; and
a position sensor, electrically connected to the control module and located on a moving path of the blocking member, wherein the control module is informed whether the reflection glass is in the second position through whether the position sensor senses the blocking member.

6. The multi-function peripheral according to claim 2, wherein the laser emitter is controlled by the control module to allow an energy of the first beam to be greater than an energy of the fourth beam.

7. The multi-function peripheral according to claim 1, further comprising a plurality of sensors, respectively electrically connected to the control module and located on the sheet transport path, wherein the control module is informed that the sheet is in a position on the sheet transport path according to the sensors.
